(19) United States
(12) Patent Application Publication
(10) Pub. No.: US 2014/0213722 A1
(43) Pub. Date: Jul. 31, 2014

(54) THERMOSETTING COMPOSITION, HARDENED FILM AND ELECTRONIC COMPONENT

(71) Applicant: JNC CORPORATION, Tokyo (JP)

(72) Inventors: TAKAYUKI HIROTA, CHIBA (JP); HIROSHI ANRAKU, CHIBA (JP); AYAKO KIKUCHI, CHIBA (JP); HIROYUKI SATO, CHIBA (JP)

(73) Assignee: JNC CORPORATION, Tokyo (JP)

(21) Appl. No.: 14/164,261

(22) Filed: Jan. 27, 2014

(30) Foreign Application Priority Data
Jan. 28, 2013 (JP) 2013-013095

(51) Int. Cl. C08G 73/10; C09D 179/08

(52) U.S. Cl. CPC C08G 73/1071; C09D 179/08
USPC 524/600; 528/185

(57) ABSTRACT

A thermosetting composition containing a compound (A) and a compound (B) is described, wherein the compound (A) is a carboxylic acid ester having at least one group represented by formula (1):

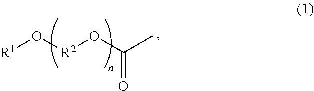

and the compound (B) is a diamine. In formula (1), R¹ is alkyl having 1 to 10 carbons, R² is independently alkylene having 2 or 3 carbons, and n is an integer of 1 to 3.

### CROSS-REFERENCE TO RELATED APPLICATION

This application claims priority benefits of Japan Patent Application No. 2013-013095, filed on Jan. 28, 2013. The entirety of the above-mentioned patent application is hereby incorporated by reference herein and made a part of this specification.

### TECHNICAL FIELD

The invention relates to a thermosetting composition, a hardened film and an electronic component, and relates to a thermosetting composition comprising specific carboxylic acid ester and diamine, a hardened film obtained from the composition, and an electronic component having the hardened film.

More specifically, the invention relates to a thermosetting composition possibly used for forming an insulation film layer in manufacturing an electronic component, a hardened film obtained from the composition, and an electronic component having the hardened film.

### BACKGROUND ART

In the field of electronics and communication, polyimide films are widely used for excellent heat resistance and electrical insulation (Patent Literatures 1 to 3).

Moreover, upon manufacturing a film, a solution coating method is employed in view of productivity and ease of film formation.

As a material for forming a polyimide film by applying the solution coating method, various kinds of proposals have been made for a solution containing a polyimide, a solution containing a polyamide acid or the like that is converted into polyimide by curing (Patent Literatures 4 to 8).

Upon coating, use of a solution having viscosity allowing coating is required. However, anyone of the solutions described in the Patent Literatures contains a polymer having a high degree of polymerization and therefore has a high viscosity, and a decrease in polymer concentration has been required for preparing a solution allowing coating.

However, the polymer having a high degree of polymerization has low solubility in a solvent. Therefore, even if a polymer concentration is decreased, preparation of a solution has been difficult, and even if preparation of a solution having a low polymer concentration has been allowed, storage stability for a long period of time has been low due to precipitation of a polymer component, or the like, and film productivity has also decreased.

In order to solve such a problem, for example, a report has been made for a polyimide precursor dispersion liquid composed of a polyimide precursor including a tetracarboxylic acid represented by a specific formula (and/or an ester derivative thereof) and a diamine, and a solvent that does not dissolve the polyimide precursor (Patent Literature 9).

### CITATION LIST

### Patent Literatures

Patent Literature 1: JP 2000-039714 A.
Patent Literature 2: JP 2003-238683 A.
Patent Literature 3: JP 2004-094118 A.
Patent Literature 4: JP 2009-221309 A.
Patent Literature 5: JP 2009-120811 A.
Patent Literature 6: JP 2010-189631 A.
Patent Literature 7: JP S60-210630 A.
Patent Literature 8: JP S59-164328 A.
Patent Literature 9: JP 2000-290369 A.

However, when a hardened film is formed using a dispersion liquid described in the Patent Literature 9, the film surface has been found to be swollen in a heat treatment, and it is difficult to obtain a hardened film having flatness (being uniform in thickness). Moreover, when the dispersion liquid is used, difficulty has been found in obtaining a hardened film having characteristics similar to those of a hardened film obtained from a conventional composition containing polyimide or polyamide acid.

### SUMMARY OF INVENTION

Accordingly, the invention provides a thermosetting composition having a low viscosity and excellent storage stability even when the solute concentration is high to allow formation of an excellent hardened film well balanced between film flatness, heat resistance and mechanical characteristics.

In order to solve the problem described above, the present inventors have diligently continued research. As a result, the present inventors have found that the problem can be solved by using a thermosetting composition comprising a specific carboxylic acid ester (A) and a diamine (B), thus completing the invention. More specifically, the invention is as described in the items below.

Item 1 is a thermosetting composition comprising:

(A) a carboxylic acid ester having at least one group represented by formula (1); and
(B) a diamine.

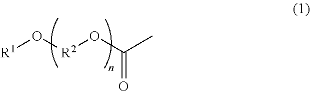

In formula (1), R¹ is alkyl having 1 to 10 carbons, R² is independently alkylene having 2 or 3 carbons, and n is an integer of 1 to 3.

Item 2 is the thermosetting composition of item 1 in which the carboxylic acid ester (A) is obtained by allowing a carboxylic anhydride (a1) to react with a compound (a2) represented by formula (2).

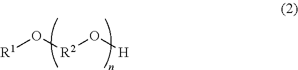

In formula (2), R¹ is alkyl having 1 to 10 carbons, R² is independently alkylene having 2 or 3 carbons, and n is an integer of 1 to 3.

Item 3 is the thermosetting composition of item 2 in which the carboxylic anhydride (a1) is at least one compound selected from the group consisting of a tetracarboxylic anhydride, and a dicarboxylic anhydride having a thermo-reactive unsaturated bond.

Item 4 is the thermosetting composition of item 2 or 3 in which the carboxylic anhydride (a1) is at least one compound selected from the group consisting of 3,3′,4,4′-biphenyl tetracarboxylic dianhydride, pyromellitic dianhydride, 3,3′,4,4′-benzophenone tetracarboxylic dianhydride, 2,2′,3,3′-benzophenone tetracarboxylic dianhydride, 2,3,3′,4′-benzophenone tetracarboxylic dianhydride, 3,3′,4,4′-diphenylsulfone tetracarboxylic dianhydride, 2,2′,3,3′-diphenylsulfone tetracarboxylic dianhydride, 2,3,3′,4′-diphenylsulfone tetracarboxylic dianhydride, 3,3′,4,4′-diphenylether tetracarboxylic dianhydride, 2,2′,3,3′-diphenylether tetracarboxylic dianhydride, 2,3,3′,4′-diphenylether tetracarboxylic dianhydride, 2,2-[bis(3,4-dicarboxyphenyl)]hexafluoropropane dianhydride, ethyleneglycol bis(anhydrotrimellitate), 4,4′-[(isopropylidene)bis(p-phenyleneoxy)]diphthalic dianhydride, cyclobutane tetracarboxylic dianhydride, methylcyclobutane tetracarboxylic dianhydride, cyclopentane tetracarboxylic dianhydride, 1,2,4,5-cyclohexane tetracarboxylic dianhydride, ethane tetracarboxylic dianhydride, butane tetracarboxylic dianhydride, 3,3′,4,4′-bicyclohexyl tetracarboxylic dianhydride, 4-ethynyl phthalic anhydride and 4-phenylethynyl phthalic anhydride.

Item 5 is the thermosetting composition of any one of items 1 to 4 in which the diamine (B) is at least one compound selected from the group consisting of 3,3′-diaminodiphenylsulfone, 4,4′-diaminodiphenyl ether, bis[4-(3-aminophenoxy)phenyl]sulfone, 3,3′-diaminodiphenylmethane, 4,4′-diaminodiphenylmethane, 2,2′-diaminodiphenylpropane, 3,3′-dimethyl-4,4′-diaminodiphenylmethane, 2,2-bis[4-(4-aminophenoxy)phenyl]propane, 2,2-bis[4-(4-aminophenoxy)phenyl]hexafluoropropane, m-phenylenediamine, p-phenylenediamine, m-xylylenediamine, p-xylylenediamine, benzidine, 1,1-bis[4-(4-aminophenoxy)phenyl]cyclohexane, 1,1-bis[4-(4-aminophenoxy)phenyl]-4-methylcyclohexane, 1,1-bis[4-(4-aminobenzyl)phenyl]cyclohexane, 1,1-bis[4-(4-aminobenzyl)phenyl]-4-methylcyclohexane, 1,1-bis[4-(4-aminobenzyl)phenyl]methane, 1,3-bis(4-aminophenoxy)benzene, diethylene glycol bis(3-aminopropyl)ether, 3,3′-dimethoxybenzidine, isophoronediamine, 3,3′-dihydroxybenzidine, a dimer acid diamine and a compound represented by formula (3).

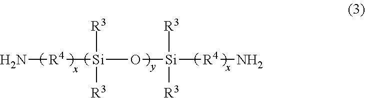

In formula (3), R³ is independently alkyl having 1 to 3 carbons or phenyl, R⁴ is independently methylene or phenylene, at least one hydrogen of the phenylene may be replaced by alkyl having 1 to 6 carbons, x is independently an integer of 1 to 6, and y is an integer of 1 to 70.

Item 6 is the thermosetting composition of any one of items 1 to 5 which further comprises a solvent (C).

Item 7 is a hardened film obtained by hardening the thermosetting composition of any one of items 1 to 6.

Item 8 is an electronic component having the hardened film of item 7.

According to the invention, a thermosetting composition, which has a low viscosity and excellent storage stability even when the solute concentration is high to allow formation of an excellent hardened film well balanced between film flatness, heat resistance, mechanical characteristics and so forth, can be obtained.

### DESCRIPTION OF EMBODIMENTS

### 1. Thermosetting Composition

The thermosetting composition of the invention (hereinafter, also referred to simply as “a composition of the invention”) is not particularly limited, as long as it comprises a specific carboxylic acid ester (A) and a diamine (B).

The composition of the invention comprises the carboxylic acid ester (A) and the diamine (B) as described above but not a polyimide or a polyamide acid, and therefore forms a thermosetting composition having low viscosity and excellent storage stability even when the solute concentration is high to allow formation of an excellent hardened film well balanced between film flatness, heat resistance, mechanical characteristics and so forth.

“Solute concentration” in the invention refers to the concentration of a component in the composition of the invention that can form a polymer in the hardened material on forming the hardened material from the composition.

The composition of the invention may also comprise, when necessary, a solvent and an additive in a range that advantageous effects of the invention are not adversely affected. The composition may be either colorless or colored.

1-1. Carboxylic Acid Ester (A)

The carboxylic acid ester (A) (also referred to as “component (A)”) has at least one group represented by formula 1 below.

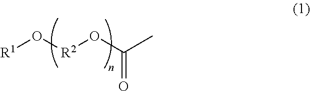

In formula (1), R¹ is alkyl having 1 to 10 carbons, R² is independently alkylene having 2 or 3 carbons, and n is an integer of 1 to 3.

Carboxylic anhydride has been so far used in place of the specific carboxylic acid ester (A). However, the carboxylic anhydride ordinarily reacts with the diamine (B) even at room temperature, and therefore the properties have changed or a polymerized polymer has precipitated during storage of the composition in some cases. Consequently, such a composition has required frozen storage.

On the other hand, according to the invention, the thermosetting composition contains the specific carboxylic acid ester (A), and therefore forms a composition having the advantageous effects described above, in particular, a composition having excellent storage stability and ease of storage at room temperature.

The carboxylic acid ester (A) is preferably a compound obtained by allowing a carboxylic anhydride (a1) to react with a compound (a2).

1-1-1. Carboxylic Anhydride (a1)

The carboxylic anhydride (a1) is not particularly restricted, and is preferably a carboxylic anhydride containing an aromatic ring. In view of allowing obtainment of an excellent hardened film well balanced between film flatness, heat resistance, mechanical characteristics and so forth, the carboxylic anhydride (a1) is further preferably a tetracarboxylic anhydride and/or a dicarboxylic anhydride having a thermo-reactive unsaturated bond, and still further preferably, a compound that can be dissolved in the compound (a2).

The carboxylic anhydride (a1) may be used alone or in combination of two or more kinds.

Moreover, a tetracarboxylic anhydride and a dicarboxylic anhydride having the thermo-reactive unsaturated bond may be simultaneously used. When the materials are simultaneously used as the carboxylic anhydride (a1), crosslinking is caused between polyimide chains to allow formation of a hardened film having superb heat resistance and mechanical characteristics.

1-1-1-1. Dicarboxylic Anhydride Having a Thermo-Reactive Unsaturated Bond

The dicarboxylic anhydride having a thermo-reactive unsaturated bond is not particularly restricted.

Specific examples of the group having the thermo-reactive unsaturated bond include a group having a polymerizable double bond, an ethynyl group, a propa-2-yn-1-yl group and a buta-3-yn-1-yl group, and preferably, an ethynyl group in view of crosslinking reactivity, heat resistance of the resulting hardened material and so forth.

Specific examples of the dicarboxylic anhydride having the thermo-reactive unsaturated bond include 4-ethynyl phthalic anhydride (abbreviation: 4-EPA), 4-phenylethynyl phthalic anhydride, maleic anhydride, citraconic anhydride, itaconic anhydride, allylnadic anhydride, 5-norbornene-2,3-dicarboxylic anhydride, cyclohexene-1,2-dicarboxylic anhydride, exo-3,6-epoxy-1,2,3,6-tetrahydrophthalic anhydride and allyl succinic anhydride.

Among the compounds, 4-ethynyl phthalic anhydride is preferred in view of being dissolved in the compound (a2) and allowing obtainment of an excellent hardened film well balanced between film flatness, heat resistance, mechanical characteristics and so forth.

1-1-1-2. Tetracarboxylic Anhydride

Specific examples of the tetracarboxylic anhydride include 3,3′,4,4′-biphenyltetracarboxylic dianhydride (abbreviation: s-BPDA), pyromellitic dianhydride (abbreviation: PMDA), 3,3′,4,4′-benzophenone tetracarboxylic dianhydride, 2,2′,3,3′-benzophenone tetracarboxylic dianhydride, 2,3,3′,4′-benzophenone tetracarboxylic dianhydride, 3,3′,4,4′-diphenylsulfone tetracarboxylic dianhydride, 2,2′,3,3′-diphenylsulfone tetracarboxylic dianhydride, 2,3,3′,4′-diphenylsulfone tetracarboxylic dianhydride, 3,3′,4,4′-diphenyl ether tetracarboxylic dianhydride (abbreviation: ODPA), 2,2′,3,3′-diphenyl ether tetracarboxylic dianhydride, 2,3,3′,4′-diphenyl ether tetracarboxylic dianhydride, 2,2-bis(3,4-dicarboxyphenyl)hexafluoropropane dianhydride, ethyleneglycol bis(anhydrotrimellitate), 4,4′-[(isopropylidene)bis(p-phenyleneoxy)]diphthalic dianhydride, cyclobutane tetracarboxylic dianhydride, methylcyclobutane tetracarboxylic dianhydride, cyclopentane tetracarboxylic dianhydride, 1,2,4,5-cyclohexane tetracarboxylic dianhydride, ethane tetracarboxylic dianhydride, butane tetracarboxylic dianhydride and 3,3′,4,4′-bicyclohexyl tetracarboxylic dianhydride.

Among the compounds, in view of being dissolved in compound (a2) and allowing obtainment of an excellent hardened film well balanced between film flatness, heat resistance, mechanical characteristics and so forth, 3,3′,4,4′-biphenyltetracarboxylic dianhydride (abbreviation: s-BPDA), pyromellitic dianhydride (abbreviation: PMDA) and 3,3′,4,4′-diphenyl ether tetracarboxylic dianhydride (abbreviation: ODPA) are preferred.

1-1-2. Compound (a2)

Compound (a2) is represented by formula (2) below.

When such compound (a2) is used, a thermosetting composition, which can form an excellent hardened film well balanced between film flatness, heat resistance, mechanical characteristics and so forth, can be obtained.

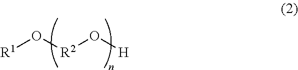

In formula (2), R¹ is alkyl having 1 to 10 carbons, R² is independently alkylene having 2 or 3 carbons, and n is an integer of 1 to 3.

R¹ is preferably alkyl having 1 to 6 carbons, and further preferably, alkyl having 1 to 4 carbons in view of allowing easy synthesis of the carboxylic acid ester (A) and allowing obtainment of a composition that can form an excellent hardened film well balanced between film flatness, heat resistance, mechanical characteristics and so forth.

The alkyl may be a straight chain or a branched chain, but is preferably a straight chain.

When n is 2 or more, the plurality of R² may be independently identical or different with each other. The rule applies to a compound represented by any other formula.

R² is preferably alkylene having 2 carbons.

The alkylene may be a straight chain or a branched chain, but is preferably a straight chain.

n is preferably 2 or 3, and is further preferably 2 in view of allowing easy synthesis of the carboxylic acid ester (A) and allowing obtainment of a composition that can form an excellent hardened film well balanced between film flatness, heat resistance, mechanical characteristics and so forth.

The compound (a2) preferably has been predetermined for the structure and the boiling point thereof.

For the structure, the compound (a2) is preferably a straight-chain compound as represented by formula (2). As for the boiling point, compound (a2) preferably has a boiling point of about 100 to about 260° C., and further preferably, about 120 to about 240° C.

The composition of the invention comprises the carboxylic acid ester (A), which is preferably a compound obtained by allowing the carboxylic anhydride (a1) to react with the compound (a2). Esterification thereof ordinarily requires a certain degree of temperature, so use of a compound (a2) having a low boiling point does not allow the reaction at a high temperature. Therefore, unless compound (a2) is allowed to react at low temperature for long time, the carboxylic acid ester (A) may not be synthesized and the composition may not be obtained with satisfactory productivity in its preparation.

Moreover, the composition of the invention is preferably heated to cause imidization in use. On the occasion, a component derived from the compound (a2) is ordinarily eliminated from the carboxylic acid ester (A) through volatilization. The imidization is performed under a certain degree of high temperature. Therefore, if the boiling point of the to-be-eliminated component is overly low, the component may occasionally volatilize rapidly in forming the hardened material to cause swelling of the hardened material, resulting in generation of a defect derived from a foam or a bubble to the hardened material.

On the other hand, if the boiling point of the to-be-eliminated component is overly high, the component does not volatilize and remains in the hardened material in the process of imidization, and therefore further heating may be occasionally required to cause poor productivity of the hardened film.

Therefore, the boiling point of the compound (a2) is preferably within the above range. However, even when an alcohol having a boiling point within the above range does not have the structure represented by formula (2), such a compound tends not to produce advantageous effects of the invention.

For example, even when, e.g., an alcohol having a branch does not have the structure represented by formula (2), such a compound may occasionally have a boiling point in the above range. However, when such a compound is used, synthesis of the carboxylic acid ester (A) is quite difficult, and elimination of a component derived from the alcohol from the carboxylic acid ester (A) becomes difficult. Therefore, such a compound tends not to allow obtainment of a hardened material having desired characteristics, such as the characteristics of a conventional polyimide film.

Specific examples of the compound (a2) include ethylene glycol monomethyl ether, ethylene glycol monoethyl ether, ethylene glycol monopropyl ether, ethylene glycol monobutyl ether, ethylene glycol monopentyl ether, ethylene glycol monohexyl ether, ethylene glycol monoheptyl ether, ethylene glycol monooctyl ether, ethylene glycol monononyl ether, diethylene glycol monomethyl ether, diethylene glycol monoethyl ether (ethylcarbitol, abbreviation: ECa), diethylene glycol monopropyl ether, diethylene glycol monobutyl ether, diethylene glycol monopentyl ether, diethylene glycol monohexyl ether, diethylene glycol monoheptyl ether, diethylene glycol monooctyl ether, diethylene glycol monononyl ether, triethylene glycol monomethyl ether, triethylene glycol monoethyl ether, triethylene glycol monopropyl ether, triethylene glycol monobutyl ether, triethylene glycol monopentyl ether, triethylene glycol monohexyl ether, triethylene glycol monoheptyl ether, triethylene glycol monooctyl ether, triethylene glycol monononyl ether, propylene glycol monomethyl ether, propylene glycol monoethyl ether, propylene glycol monopropyl ether, propylene glycol monobutyl ether, propylene glycol monopentyl ether, propylene glycol monohexyl ether, propylene glycol monoheptyl ether, propylene glycol monooctyl ether, propylene glycol monononyl ether, dipropylene glycol monomethyl ether, dipropylene glycol monoethyl ether, dipropylene glycol monopropyl ether, dipropylene glycol monobutyl ether, dipropylene glycol monopentyl ether, dipropylene glycol monohexyl ether, dipropylene glycol monoheptyl ether, dipropylene glycol monooctyl ether, dipropylene glycol monononyl ether, tripropylene glycol monomethyl ether, tripropylene glycol monoethyl ether, tripropylene glycol monopropyl ether, tripropylene glycol monobutyl ether, tripropylene glycol monopentyl ether, tripropylene glycol monohexyl ether, tripropylene glycol monoheptyl ether, tripropylene glycol monooctyl ether and tripropylene glycol monononyl ether.

Among the compounds, diethylene glycol monoethyl ether is preferred in view of allowing easy synthesis of the carboxylic acid ester (A) and allowing obtainment of a composition that can form an excellent hardened film well balanced between film flatness, heat resistance, mechanical characteristics and so forth.

1-1-3. Conditions for Synthesizing Carboxylic Acid Ester (A)

The carboxylic acid ester (A) is preferably obtained by allowing the acid anhydride group in the carboxylic anhydride (a1) to react with the hydroxyl group in the compound (a2).

When the total molar number of the acid anhydride group in the carboxylic anhydride (a1) is taken as a and the total molar number of the hydroxyl group in the compound (a2) is taken as β, the ratio of (a2) to (a1) in the reaction is preferably 1 or more in terms of p/a in view of allowing obtainment of a composition that has excellent stability and can forma hardened material well balanced between film flatness, heat resistance, mechanical characteristics and so forth.

The temperature in the reaction is ordinarily about 60 to about 160° C., and preferably about 70 to about 160° C. The reaction time is ordinarily about 0.5 to about 10 hours, and preferably about 0.5 to about 8 hours. The reaction pressure is a normal pressure, for example.

1-2. Diamine (B)

The diamine (B) (hereinafter, also referred to as “component (B)”) is not particularly restricted as long as it is a compound having two amino groups, and is preferably a compound having two —NH₂, and further preferably a compound having two —NH₂ and having an aromatic ring in view of allowing obtainment of an excellent hardened film well balanced between heat resistance, mechanical characteristics and so forth.

The diamine (B) may be used alone or in combination of two or more kinds.

Specific examples of the diamine (B) include 3,3′-diaminodiphenylsulfone (abbreviation: DDS), 4,4′-diaminodiphenyl ether (abbreviation: DDE), bis[4-(3-aminophenoxy)phenyl]sulfone (abbreviation: BAPS-M), 3,3′-diaminodiphenylmethane, 4,4′-diaminodiphenylmethane, 2,2′-diaminodiphenyl propane, 3,3′-dimethyl-4,4′-diaminodiphenylmethane, 2,2-bis[4-(4-aminophenoxy)phenyl]propane (abbreviation: BAPP), 2,2-bis[4-(4-aminophenoxy)phenyl]hexafluoropropane (abbreviation: HFBAPP), m-phenylenediamine, p-phenylenediamine, m-xylylenediamine, p-xylylenediamine, benzidine, 1,1-bis[4-(4-aminophenoxy)phenyl]cyclohexane, 1,1-bis[4-(4-aminophenoxy)phenyl]-4-methylcyclohexane, 1,1-bis[4-(4-aminobenzyl)phenyl]cyclohexane, 1,1-bis[4-(4-aminobenzyl)phenyl]-4-methylcyclohexane, 1,1-bis[4-(4-aminobenzyl)phenyl]methane, 1,3-bis(4-aminophenoxy)benzene (abbreviation: TPE-R), diethylene glycol bis(3-aminopropyl)ether, 3,3′-dimethoxybenzidine (abbreviation: DMB), isophoronediamine, a dimer acid diamine, 3,3′-dihydroxybenzidine and a compound represented by formula (3) below.

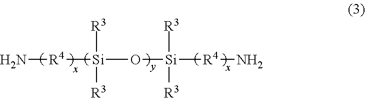

In formula (3), R³ is independently alkyl having 1 to 3 carbons or phenyl, R⁴ is independently methylene or phenylene, at least one hydrogen of the phenylene may be replaced by alkyl having 1 to 6 carbons, x is independently an integer of 1 to 6, and y is an integer of 1 to 70.

The alkyl having 1 to 6 carbons that may be used for a substitution on the phenylene is not particularly restricted, but is preferably alkyl having 1 to 3 carbons.

The dimer acid diamine is obtained by, for example, a reductive amination reaction of a dimer acid. The reaction can be performed, for example, by a reduction method using ammonia and a catalyst, or a publicly known method as described in JP H9-12712 A.

The dimer acid is a dibasic acid obtained by dimerization of an unsaturated fatty acid by an intermolecular polymerization reaction or the like. The dimer acid composition ordinarily comprises a small amount of monomer acid, trimer acid or the like in addition to the dimer acid, and the amount thereof depends on the synthesis conditions and purification conditions. After the dimerization, a double bond remains in the resulting molecule. According to the invention, the dimer acid may alternatively be a compound in which the double bond in the molecule is reduced and converted into saturated dibasic acid by a hydrogenation reaction.

Specifically, for example, the dimer acid is obtained by polymerizing an unsaturated fatty acid using a Lewis acid or a Broensted acid as a catalyst. The dimer acid can be synthesized by a publicly known method as described in, e.g., JP H9-12712 A.

Specific examples of the unsaturated fatty acid include at least one compound selected from the group consisting of myristoleic acid, palmitoleic acid, Sapienic acid, oleic acid, elaidic acid, stearolic acid, vaccenic acid, gadoleic acid, eicosenic acid, erucic acid, brassidic acid, nervonic acid, linolic acid, eicosadienoic acid, docosadienoic acid, α-linolenic acid, γ-linolenic acid, pinolenic acid, eleostearic acid, mead acid, dihomo-γ-linolenic acid, eicosatrienoic acid, stearidonic acid, arachidic acid, eicosatetraenoic acid, cetoleic acid, adrenic acid, bosseopentaenoic acid, osbond acid, clupanodonic acid, tetracosapentaenoic acid, eicosapentaenoic acid, docosahexaenoic acid and nisinic acid.

The number of carbons of the unsaturated fatty acid is preferably 4 to 24, and further preferably 14 to 20.

For example, when the dimer acid is manufactured using linolic acid, the resulting mixture generally contains the dimer acid having 36 carbons as a main component, but generally contains the monomer acid having 18 carbons, the trimer acid having 54 carbons and so on, and contains various kinds of structures derived from the raw material.

The dimer acid diamine is preferably, for example, a compound having a structure represented by any one of formulas (a) to (f) below, or a compound in which the unsaturated bonds are partially or entirely converted into single bonds.

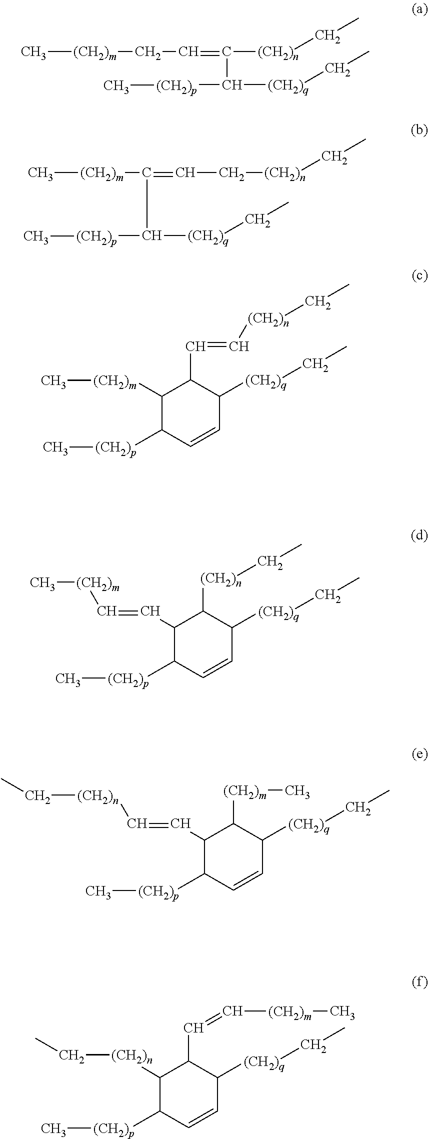

In formulas (a) to (f), m, n, p and q are each independently an integer of 0 to 15.

Specific examples of commercial items of dimer acid diamine include VERSAMINE 551 (trade name, BASF Japan Ltd.) and PRIAMINE 1074 (trade name, Croda Japan K.K.). The scope of the dimer acid diamine also includes a compound formed by hydrogenation of a diamine obtained with a reductive amination reaction of a dimer acid, and specific commercial examples of the diamine obtained with a reductive amination reaction of a dimer acid include VERSAMINE 552 (trade name, BASF Japan Ltd.).

Preferred examples of the diamine (B) include DDS, DDE, BAPS-M, BAPP, HFBAPP, TPE-R and DMB in view of allowing obtainment of a composition that can form an excellent hardened film well balanced between film flatness, heat resistance, mechanical characteristics and so forth.

The diamine (B) is preferably a compound represented by formula (4) below in view of allowing obtainment of a composition that can form an excellent hardened film well balanced between film flatness, heat resistance, mechanical characteristics and so forth. In particular, when ODPA, PMDA, s-BPDA or 4-EPA is used as the carboxylic anhydride (a1), use of the compound as the diamine (B) is preferred due to, in addition to the effect described above, preventing the hardened film obtained from having an excessive hardness, and difficulty in causing film thickness unevenness, a defect derived from a foam or a bubble, a crack, or the like.

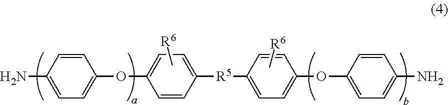

In formula (4), R⁵ is a single bond, —O—, —C(CH₃)₂— or —C(CF₃)₂—, R⁶ is independently alkyl having 1 to 3 carbons or alkoxy having 1 to 3 carbons, and a and b are each independently 0 or 1.

1-3. Content of Components (A) and (B)

When the total molar number of the group represented by formula (1) in the component (A), and the carboxyl group and the acid anhydride group that may be included in the component (A) is taken as N′, and the total molar number of the amino group in the component (B) is taken as M, the components (A) and (B) are desirably contained, in terms of N′/M, in a ratio of preferably about 0.5 to about 5, and further preferably about 0.75 to about 4.5, in the composition of the invention.

Moreover, in a case where the component (A) is a compound obtained by allowing the carboxylic anhydride (a1) to react with the compound (a2), when the total molar number of the acid anhydride group of the carboxylic anhydride (a1) used is taken as N, and the total molar number of the amino group in the component (B) is taken as M, the components (A) and (B) are desirably contained, in terms of N/M, in a ratio of preferably about 0.75 to about 1.25, and further preferably about 0.9 to about 1.1, in the composition of the invention.

A case where the content of the components (A) and (B) is in the above range is preferred in view of a small amount of unreacted components (A) and (B) remaining in the hardened film upon forming the hardened film from the composition of the invention, and favorable characteristics of the hardened film obtained.

1-4. Solvent (C)

The composition of the invention may also comprise, when necessary, a solvent (C) for adjusting the solute concentration, the viscosity or the like.

Such solvent (C) preferably includes a solvent that can dissolve the components (A) and (B) in view of allowing obtainment of a composition having excellent storage stability.

If the boiling point of the solvent (C) is too low, film flatness of the hardened film obtained may occasionally decrease. If the boiling point is too high, the solvent remains in the hardened film obtained, and the film characteristics may decrease. Consequently, the boiling point of the solvent (C) is preferably in the range of about 90 to about 300° C., and further preferably in the range of about 100 to about 280° C.

Specific examples of the solvent (C) include dimethyl sulfoxide, 1-methyl-2-pyrrolidone, N,N-dimethylformamide, N,N-dimethylacetamide, N,N-diethylacetamide, N,N-dimethylpropionamide, diethylene glycol ethyl methyl ether, triethylene glycol dimethyl ether, γ-butyrolactone, ethylene glycol, propylene glycol, glycerol, ethylene glycol monomethyl ether, ethylene glycol monobutyl ether, ethylene glycol monophenyl ether, ethylene glycol dimethyl ether, ethylene glycol monomethyl ether acetate, ethylene glycol monoethyl ether acetate, diethylene glycol monomethyl ether, diethylene glycol monobutyl ether, diethylene glycol diethyl ether, diethylene glycol dibutyl ether, diethylene glycol isopropylmethyl ether, diethylene glycol butyl methyl ether, diethylene glycol monoethyl ether acetate, triethylene glycol monomethyl ether, triethylene glycol divinyl ether, propylene glycol monomethyl ether(1-methoxy-2-propanol), propylene glycol monoethyl ether(1-ethoxy-2-propanol), propylene glycol monobutyl ether(1-butoxy-2-propanol), propylene glycol dimethyl ether, propylene glycol monomethyl ether acetate, dipropylene glycol monomethyl ether, dipropylene glycol dimethyl ether, tripropyllene glycol monomethyl ether, tripropylene glycol dimethyl ether, α-acetyl-γ-butyrolactone, ε-caprolactone, γ-hexanolactone, δ-hexanolactone, methylethyl sulfoxide and diethylsulfoxide.

The solvents (C) may be used alone or in combination of two or more kinds.

The content of the solvent (C) may be appropriately determined according to the use of the composition of the invention and the coating method, and is preferably in the range of about 20 wt % to about 95 wt %, and further preferably about 30 wt % to about 90 wt %, based on 100 wt % of the composition of the invention in view of storage stability or the like.

1-5. Additive

The composition of the invention may comprise, depending on objective characteristics, an additive other than the component (A), the component (B) and the solvent (C) within the range in which advantageous effects of the invention are not adversely affected. Specific examples of such an additive include a macromolecular compound, an epoxy compound, an acrylic resin, a surfactant, an antistatic agent, a coupling agent, an epoxy curing agent, a pH adjuster, an anti-rust agent, a preservative, a anti-mold agent, an antioxidant, a reduction inhibitor, an evaporation accelerator, a chelating agent, a water-soluble polymer, a pigment, titanium black, carbon black and a dye. The additives may be appropriately used alone or in combination of two or more kinds depending on the objective characteristics.

1-5-1. Macromolecular Compound

The macromolecular compound is not particularly limited. Specific examples thereof include polyamide acid, soluble polyimide, polyamide, polyamideimide, polyamide acid ester, polyester, polyvinyl alcohol and polyoxyethylene. The macromolecular compounds may be used alone or in combination of two or more kinds.

In view of excellent solubility, the weight average molecular weight of the macromolecular compound is preferably in the range of about 1,000 to about 200,000, more preferably in the range of about 1,000 to about 180,000, still more preferably in the range of about 1,000 to about 160,000, and particularly preferably in the range of about 1,000 to about 150,000.

When a macromolecular compound having a weight average molecular weight in the range of about 1,000 or more is used, the macromolecular compound is not evaporated upon forming the hardened film from the composition of the invention, and thus a chemically and mechanically stable hardened film is obtained.

The weight average molecular weight of the macromolecular compound can be measured with a gel permeation chromatography (GPC) method.

The concentration of the macromolecular compound in the composition of the invention is ordinarily in the range of about 0 to about 20 wt %, and preferably, in the range of about 0 to about 10 wt %. When the concentration of the macromolecular compound is in such range, a hardened film having good film flatness, heat resistance and mechanical characteristics tends to be obtained.

1-5-2. Epoxy Compound

The epoxy compound is not particularly limited, as long as it has an oxirane group or an oxetane group. A compound having two or more oxirane groups is preferred.

According to the invention, even when having an acryloyl group or a methacryloyl group, a polymer formed from a monomer containing an oxirane group or an oxetane group is referred to as an epoxy compound, and an alkoxysilane containing an oxirane group or an oxetane group is also referred to as an epoxy compound.

The case where the composition of the invention comprises the epoxy compounds is preferred because a hardened film having excellent heat resistance is obtained thereby.

Specific examples of the epoxy compound include a bisphenol A epoxy compound, a glycidyl ester epoxy compound, an alicyclic epoxy compound, a polymer of a monomer having an oxirane group or an oxetane group, and a copolymer of a monomer having an oxirane group or an oxetane group and any other monomer.

Specific examples of the monomer having an oxirane group or an oxetane group include glycidyl (meth)acrylate, methyl glycidyl (meth)acrylate, 3,4-epoxycyclohexyl (meth)acrylate, (3-ethyl-3-oxetanyl)methyl (meth)acrylate, 3-ethyl-3-(meth)acryloxy methyl oxetane, 3-methyl-3-(meth)acryloxy ethyl oxetane, 3-ethyl-3-(meth)acryloxy ethyl oxetane, 3-methyl-3-(meth)acryloxy methyl oxetane, 2-phenyl-3-(meth)acryloxy methyl oxetane, 2-trifluoromethyl-3-(meth)acryloxy methyl oxetane and 4-trifluoromethyl-2-(meth)acryloxy methyl oxetane.

Specific examples of any other monomer to be copolymerized with the monomer having an oxirane group or an oxetane group include (meth)acrylic acid, methyl (meth)acrylate, ethyl (meth)acrylate, isopropyl (meth)acrylate, n-butyl (meth)acrylate, iso-butyl (meth)acrylate, tert-butyl (meth)acrylate, cyclohexyl (meth)acrylate, benzyl (meth)acrylate, 2-hydroxyethyl (meth)acrylate, 2-hydroxypropyl (meth)acrylate, styrene, methylstyrene, chloromethylstyrene, (3-ethyl-3-oxetanyl)methyl (meth)acrylate, N-cyclohexylmaleimide and N-phenylmaleimide.

Preferred specific examples of the polymer of the monomer having an oxirane group or an oxetane group, and the copolymer of the monomer having an oxirane group or an oxetane group and any other monomer include polyglycidyl (meth)acrylate, a methyl (meth)acrylate-glycidyl (meth)acrylate copolymer, a benzyl (meth)acrylate-glycidyl (meth)acrylate copolymer, a n-butyl (meth)acrylate-glycidyl (meth)acrylate copolymer, a 2-hydroxyethyl (meth)acrylate-glycidyl (meth)acrylate copolymer, a (3-ethyl-3-oxetanyl)methyl (meth)acrylate-glycidyl (meth)acrylate copolymer and a styrene-glycidyl (meth)acrylate copolymer.

Specific examples of the alkoxysilanes having an oxirane group or an oxetane group include γ-glycidoxypropylmethyldimethoxysilane, γ-glycidoxypropyltrimethoxysilane, γ-glycidoxypropylmethyldiethoxysilane and γ-glycidoxypropyltriethoxysilane.

Specific examples of the epoxy compounds include “jER 807,” “jER 815,” “jER 825,” “jER 827,” “jER 828,” “jER 190P,” “jER 191P,” “jER 1004” and “jER 1256” (trade names, from Mitsubishi Chemical Corporation), “Araldite CY177” and “Araldite CY184” (trade names, from Huntsman Japan K.K.), “Celloxide 2021P,” “Celloxide 3000” and “EHPE-3150” (trade names, from Daicel Chemical Industries, Ltd.), “Techmore VG3101L” (trade name, from Printec Corporation), N,N,N′,N′-tetraglycidyl-m-xylenediamine, 1,3-bis(N,N-diglycidylaminomethyl)cyclohexane and N,N,N′,N′-tetraglycidyl-4,4′-diaminodiphenylmethane. Among the compounds, use of Araldite CY184, Celloxide 2021P, Techmore VG3101L or jER 828 is preferred because a hardened film having a particularly good film flatness is obtained thereby.

Specific examples of the epoxy compounds further include compounds represented by formula (I) to formula (VI) below. Among the compounds, compounds represented by formulas (I), (V) and (VI) below are preferred because a hardened film having a particularly good film flatness is obtained thereby.

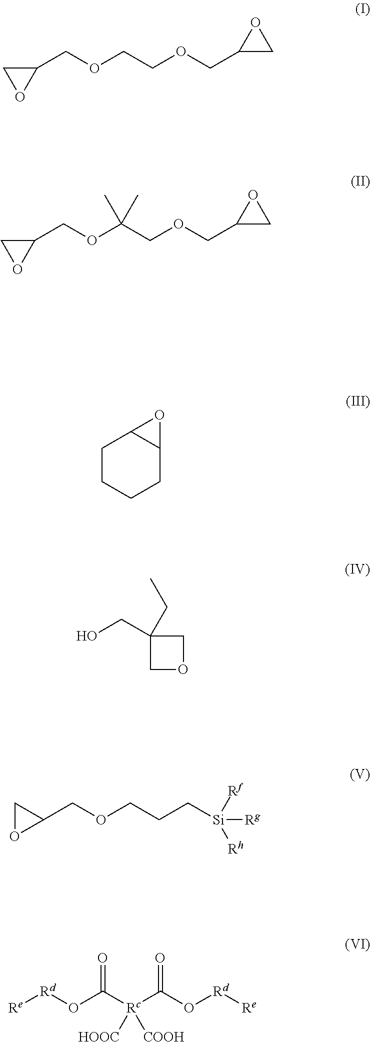

In formula (V), R^{f}, R^{g} and R^{h} are each independently hydrogen or an organic group having 1 to 30 carbons. Specific examples of the organic group having 1 to 30 carbons include a hydrocarbon group having 1 to 30 carbons.

In formula (VI), R^{c} is an organic group having 2 to 100 carbons. Specific examples of the organic group having 2 to 100 carbons include a hydrocarbon group having 2 to 100 carbons, and a group including an aromatic group having 6 to 40 carbons.

In formula (VI), each R^{d} is independently an organic group having 1 to 30 carbons. Specific examples of the organic group having 1 to 30 carbons include a straight or branched hydrocarbon group having 1 to 30 carbons, wherein a hydrocarbon group having 1 to 30 carbons that includes a ring structure or oxygen is preferred. Specific examples of the ring structure include phenyl, cyclohexyl, naphthyl, cyclohexenyl and tricyclo[5.2.1.0^{2,6}]decanyl.

In formula (VI), R^{e} is independently an organic group having an oxetane group, an oxirane group or a 1,2-epoxycyclohexane group, and is preferably an organic group selected from the group consisting of formulas (VII) to (IX) below.

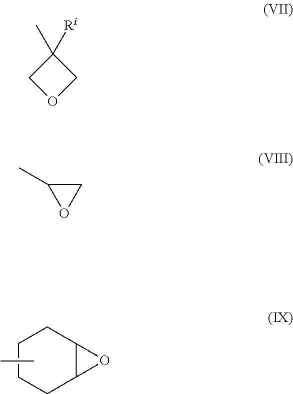

In formula (VII), Rⁱ is hydrogen or alkyl having 1 to 3 carbons.

Preferred examples of the compounds represented by formula (VI) include a compound represented by formula (X) below.

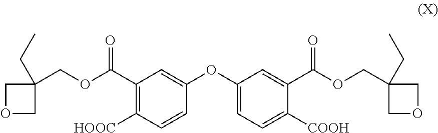 [SMILES: CCC1(COC(=O)c2cc(Oc3ccc(C(=O)O)c(C(=O)OCC4(CC)COC4)c3)ccc2C(=O)O)COC1]

The epoxy compound may be used alone or in combination of two or more kinds.

When the epoxy compound is contained in the composition of the invention, the concentration thereof in the composition is not particularly limited, but is preferably in the range of about 0.1 wt % to about 20 wt %, and more preferably in the range of about 1 wt % to about 10 wt %. When the concentration is within the above range, the film flatness, heat resistance and mechanical characteristics of the hardened film obtained become good.

1-5-3. Acrylic Resin

The acrylic resin is not particularly limited as being a polymer having an acryloyl group or a methacryloyl group. Specific examples thereof include a homopolymer of a monomer such as polymerizable monofunctional (meth)acrylate having a hydroxyl group; a polymerizable monofunctional (meth)acrylate having no hydroxyl group; a bifunctional (meth)acrylate; a trifunctional or higher functional (meth)acrylate, and a copolymer prepared from the monomers. Moreover, the acrylic resin may be a copolymer in which the monomer is copolymerized with a monomer such as styrene, methylstyrene, chloromethylstyrene, vinyltoluene, N-cyclohexylmaleimide, N-phenylmaleimide, a polystyrene macromonomer, (meth)acrylic acid, crotonic acid, α-chloroacrylic acid, cinnamic acid, maleic acid, fumaric acid, itaconic acid, citraconic acid or mesaconic acid.

“(Meth)acrylate” herein indicates both or either one of acrylate and methacrylate.

Moreover, a case where the number of polymerizable group is one is expressed as “monofunctional,” and a case where the number is two is expressed as “bifunctional.” “trifunctional or higher functional” is also expressed according to the number of polymerizable groups.

Specific examples of the polymerizable monofunctional (meth)acrylate having a hydroxyl group include 2-hydroxyethyl (meth)acrylate, 2-hydroxypropyl (meth)acrylate, 4-hydroxybutyl (meth)acrylate, glycerol mono(meth)acrylate and 1,4-cyclohexanedimethanol mono(meth)acrylate. Among the (meth)acrylates, in view of allowing a flexible hardened film to be formed, 4-hydroxy butylacrylate and 1,4-cyclohexane dimethanol monoacrylate are preferred.

Specific examples of the polymerizable monomer having no hydroxyl group include methyl (meth)acrylate, ethyl (meth)acrylate, isopropyl (meth)acrylate, butyl (meth)acrylate, iso-butyl (meth)acrylate, tert-butyl (meth)acrylate, cyclohexyl (meth)acrylate, isobornyl (meth)acrylate, phenyl (meth)acrylate, benzyl (meth)acrylate, tricyclo[5.2.1.0^{2,6}]decanyl (meth)acrylate, dicyclopentenyloxyethyl (meth)acrylate, 5-tetrahydrofurfuryl oxycarbonylpentyl (meth)acrylate, (meth)acrylate of ethylene oxide adduct of lauryl alcohol, ω-carboxypolycaprolactone mono(meth)acrylate, a polymethylmethacrylate macromonomer, mono[2-(meth)acryloyloxyethyl]succinate, mono[2-(meth)acryloyloxyethyl]maleate, mono[2-(meth)acryloyloxyethyl]cyclohexene-3,4-dicarboxylate, N-acryloyl morpholine and (meth)acrylamide.

Specific examples of the bifunctional (meth)acrylate include bisphenol-F ethylene oxide-modified di(meth)acrylate, bisphenol-A ethylene oxide-modified di(meth)acrylate, isocyanuric acid ethylene oxide-modified di(meth)acrylate, polyethylene glycol di(meth)acrylate, polypropylene glycol di(meth)acrylate, pentaerythritol di(meth)acrylate, pentaerythritol di(meth)acrylate monostearate, dipentaerythritol di(meth)acrylate, 1,4-butanediol di(meth)acrylate, 1,6-hexanediol di(meth)acrylate, 1,9-nonanediol di(meth)acrylate, 1,4-cyclohexane dimethanol di(meth)acrylate, 2-n-butyl-2-ethyl-1,3-propandiol di(meth)acrylate and trimethylolpropane di(meth)acrylate.

Specific examples of the trifunctional or higher functional (meth)acrylate include trimethylolpropane tri(meth)acrylate, ethylene oxide-modified trimethylolpropane tri(meth)acrylate, propylene oxide-modified trimethylolpropane tri(meth)acrylate, epichlorohydrin-modified trimethylolpropane tri(meth)acrylate, ditrimethylolpropane tetra(meth)acrylate, glycerol tri(meth)acrylate, epichlorohydrin-modified glycerol tri(meth)acrylate, diglycerol tetra(meth)acrylate, pentaerythritol tri(meth)acrylate, pentaerythritol tetra(meth)acrylate, dipentaerythritol penta(meth)acrylate, alkyl-modified dipentaerythritol penta(meth)acrylate, alkyl-modified dipentaerythritol tetra(meth)acrylate, alkyl-modified dipentaerythritol tri(meth)acrylate, dipentaerythritol hexa(meth)acrylate, caprolactone-modified dipentaerythritol hexa(meth)acrylate, ethylene oxide-modified phosphoric acid tri(meth)acrylate, tris[(meth)acryloxyethyl]isocyanurate, caprolactone-modified tris[(meth)acryloxyethyl]isocyanurate and urethane (meth)acrylate.

The acrylic resins may be used alone or in combination of two or more kinds.

When the acrylic resin is contained in the composition of the invention, the concentration thereof in the composition is not particularly limited, but is preferably in the range of about 0.1 to about 20 wt %, and further preferably in the range of about 1 to about 10 wt %. If the concentration is within the range described above, a hardened film having excellent film flatness, heat resistance and mechanical characteristics is obtained.

1-5-4. Surfactant

The composition of the invention may comprise a surfactant in order to improve the wettability or levelability onto a coating object such as a substrate, or the jettability when performing inkjet printing of the composition of the invention.

In view of allowing improvement of the jettability when performing inkjet printing of the composition of the invention, specific examples of the surfactant include silicone surfactants such as “BYK-300,” “BYK-306,” “BYK-335,” “BYK-310,” “BYK-341,” “BYK-344” and “BYK-370” (trade names, from BYK-Chemie GmbH); acrylic surfactants such as “BYK-354,” “BYK-358” and “BYK-361” (trade names, from BYK-Chemie GmbH); and fluorochemical surfactants such as “DFX-18,” “Futargent 250” and “Futargent 251” (trade names, from Neos Co., Ltd.).

The surfactants may be used alone or in combination of two or more kinds.

When the surfactant is contained in the composition of the invention, the concentration of the surfactant in the composition is preferably in the range of about 0.01 wt % to about 1 wt %.

1-5-5. Antistatic Agent

The antistatic agent is used in order to prevent the composition of the invention from being charged. Such an antistatic agent is not particularly limited, and a publicly known antistatic agent can be used. Specific examples thereof include metal oxides, such as tin oxide, tin oxide-antimony oxide composite oxide, tin oxide-indium oxide composite oxide and a quaternary ammonium salt.

The antistatic agents may be used alone or in combination of two or more kinds.

When the antistatic agent is contained in the composition of the invention, the concentration thereof in the composition is preferably in the range of about 0.01 wt % to about 1 wt %.

1-5-6. Coupling Agent

The coupling agent is not particularly limited, and a publicly known coupling agent can be used. A silane coupling agent is preferably used. Specific examples of the silane coupling agent include a trialkoxysilane compound and a dialkoxysilane compound.

Specific examples of the trialkoxysilane compound or the dialkoxysilane compound include γ-vinylpropyl trimethoxysilane, γ-vinylpropyl triethoxysilane, γ-acryloylpropylmethyl dimethoxysilane, γ-acryloylpropyl trimethoxysilane, γ-acryloylpropylmethyl diethoxysilane, γ-acryloylpropyl triethoxysilane, γ-methacryloylpropylmethyl dimethoxysilane, γ-methacryloylpropyl trimethoxysilane, γ-methacryloylpropylmethyl diethoxysilane, γ-methacryloylpropyl triethoxysilane, γ-aminopropylmethyl dimethoxysilane, γ-aminopropyl trimethoxysilane, γ-aminopropylmethyl diethoxysilane, γ-aminopropyl triethoxysilane, N-aminoethyl-γ-iminopropylmethyl dimethoxysilane, N-aminoethyl-γ-aminopropyl trimethoxysilane, N-aminoethyl-γ-aminopropyl triethoxysilane, N-phenyl-γ-aminopropyl trimethoxysilane, N-phenyl-γ-aminopropyl triethoxysilane, N-phenyl-γ-aminopropylmethyl dimethoxysilane, N-phenyl-γ-aminopropylmethyl diethoxysilane, γ-mercaptopropylmethyl dimethoxysilane, γ-mercaptopropylmethyl diethoxysilane, γ-mercaptopropyl trimethoxysilane, γ-mercaptopropyl triethoxysilane, γ-isocyanatopropylmethyl diethoxysilane and γ-isocyanatopropyl triethoxysilane.

Among the above compounds, γ-vinylpropyl trimethoxysilane, γ-acryloylpropyl trimethoxysilane, γ-methacryloylpropyl trimethoxysilane and γ-isocyanatopropyl triethoxysilane are particularly preferred.

The coupling agents may be used alone or in combination of two or more kinds.

When the coupling agent is contained in the composition of the invention, the concentration thereof in the composition is preferably in the range of about 0.01 wt % to about 3 wt %.

1-5-7. Epoxy Curing Agent

The epoxy curing agent is not particularly limited, and a publicly known epoxy curing agent can be used. Specifically, example of such curing agent may include an organic acid dihydrazide compound, imidazole or a derivative thereof, a dicyandiamide, an aromatic amine, a polycarboxylic acid, and a polycarboxylic anhydride.

The polycarboxylic acid is a compound having two or more carboxyl groups in one molecule.

Further specific examples of the epoxy curing agent include dicyandiamides such as dicyandiamide; organic acid dihydrazide compounds such as adipic acid dihydrazide and 1,3-bis(hydrazinocarboethyl)-5-isopropylhydantoin; imidazole derivatives such as 2,4-diamino-6-[2′-ethylimidazolyl-(1′)]-ethyltriazine, 2-phenylimidazole, 2-phenyl-4-methylimidazole and 2-phenyl-4-methyl-5-hydroxymethylimidazole; polycarboxylic anhydrides such as phthalic anhydride, trimellitic anhydride and 1,2,4-cyclohexanetricarboxylic acid-1,2-anhydride; and polycarboxylic acids such as trimellitic acid. Among the compounds, trimellitic anhydride, trimellitic acid and 1,2,4-cyclohexanetricarboxylic acid-1,2-anhydride are preferred.

The epoxy curing agents may be used alone or in combination of two or more kinds.

When the epoxy curing agent is contained in the composition of the invention, the concentration thereof in the composition is preferably in the range of about 0.2 wt % to about 5 wt %.

1-6. Physical Properties of Thermosetting Composition, or the Like

The composition of the invention comprises the components (A) and (B), and therefore a conventional and publicly known coating method such as a solution coating method can be applied without restriction even to the composition having a high solute concentration, and a hardened film can be easily formed.

Consequently, a thick hardened film can be formed even by one-time coating, and an excellent hardened film well balanced between film flatness, heat resistance, mechanical characteristics and so forth can be formed with good productivity.

Therefore, for example, the solute concentration in the composition of the invention may be increased upon forming a thick hardened film by one-time coating, and the solute concentration in the composition may be decreased when a composition having a predetermined low viscosity is required in such a case where the composition of the invention is coated by an inkjet method.

The components (A) and (B) have excellent solubility in a solvent also, and therefore such concentration adjustment can also be easily performed.

As described above, the solute concentration in the composition of the invention may be appropriately determined according to the use, but is preferably about 5 to about 80 wt %, and further preferably about 10 to about 70 wt %.

When the solute concentration in the composition of the invention is in the above range, an excellent hardened film well balanced between film flatness, heat resistance, mechanical characteristics and so forth can be easily formed with good productivity using a conventional and publicly known coating method such as the solution coating method.

Moreover, as described above, the viscosity of the composition of the invention may be appropriately adjusted according to the use, and the viscosity is preferably in the range of about 2 to about 20,000 mPa·s, and further preferably in the range of about 5 to about 15,000 mPa·s.

When the viscosity is within the above range, a hardened film can be easily formed with good productivity using a conventional and publicly known coating method such as the solution coating method.

When ordinary usage is taken into consideration, the composition of the invention desirably causes neither precipitation nor separation for about 3 days or more, and preferably about 7 days or more, under room temperature.

### 2. Hardened Film

The hardened film of the invention can be obtained by hardening the composition of the invention.

A method for manufacturing such a hardened film is not particularly restricted. However, in view of allowing formation of an excellent hardened film well balanced between film flatness, heat resistance, mechanical characteristics and so forth, a preferred method for forming a coating film includes coating the composition of the invention onto a substrate or the like (coating film-forming step), and subjecting the resultant film to a drying treatment (drying step) and a heat treatment (heating step).

2-1. Coating Film-Forming Step

A method for coating the composition of the invention onto a substrate is not particularly restricted, and a publicly known coating method can be appropriately selected and applied according to the required thickness of the hardened film, required viscosity of the composition, or the like. Specific examples thereof include coating methods using an applicator, a doctor blade knife coater, an air-knife coater, a roll coater, a rotary coater, a flow coater, a die coater and a bar coater, coating methods such as a spin coating method, a spray coating method and a dip coating method, and printing techniques typified by inkjet printing, screen printing and gravure printing.

Specific examples of the substrate on which the composition is coated include a glass epoxy substrate, a glass composite substrate, a paper phenol substrate, a paper epoxy substrate, a green epoxy substrate, and a bismaleimide triazine (BT) resin substrate in conformity with various standards of printed circuit boards, such as FR-1, FR-3, FR-4, CEM-3 or E668.

The specific examples also include a substrate including a metal such as copper, brass, phosphor bronze, copper-beryllium alloy, aluminum, gold, silver, nickel, tin, chromium or stainless steel (a substrate may have a layer including anyone of the metals on a surface); a substrate including an inorganic substance such as aluminum oxide (alumina), aluminum nitride, zirconium oxide (zirconia), silicate of zirconium (zircon), magnesium oxide (magnesia), aluminum titanate, barium titanate, lead titanate (PT), lead zirconate titanate (PZT), lead lanthanum zirconium titanate (PLZT), lithium niobate, lithium tantalate, cadmium sulfide, molybdenum sulfide, beryllium oxide (beryllia), silicon oxide (silica), silicon carbide, silicon nitride, boron nitride, zinc oxide, mullite, ferrite, steatite, forsterite, spinel or spodumene (a substrate may have a layer including any one of the inorganic substances on the surface); a substrate including a resin such as polyphenylene sulfide (PPS) resin, polyphenylene ether resin, polyimide resin, polyamide resin, polyether imide resin, polyamide imide resin and epoxy resin (a substrate may have a layer including any one of the resins on the surface); a semiconductor substrate (e.g. silicon wafer) including silicon, germanium or gallium arsenide; a glass substrate; and a substrate prepared by forming an electrode material (wiring) such as tin oxide, zinc oxide, indium tin oxide (ITO) or antimony tin oxide (ATO) on the surface.

The hardened film of the invention is preferably formed on the substrate including the polyimide resin described above and on the silicon wafer, particularly, on a film-shaped substrate including the polyimide resin, and on the silicon wafer.

2-2. Drying Step

The drying step is applied for the purpose of removing a solvent and providing the coating film with certain characteristics, and for flatness of the coating film after the heating step.

In order to obtain an excellent hardened film well balanced between film flatness, heat resistance, mechanical characteristics and so forth, the temperature in the drying step is preferably about 50° C. to about 120° C., and the time is preferably about 10 min to about 100 min on using an oven, or about 10 min to about 80 min on using a hot plate.

2-3. Heating Step

The heating step is applied for the purpose of removing a solvent remaining after the drying step, eliminating a component derived from the compound (a2) from the component (A) in the coating film and evaporating the component to form an imide bond by a reaction of the component (A) with the component (B), and depending on the carboxylic anhydride (a1) to be used, promoting a crosslinking reaction on a thermo-reactive unsaturated bond site to manufacture the hardened film, or the like.

For a reason similar to the reason in the drying step, the temperature in the heating step is preferably about 200° C. to about 450° C., and further preferably about 250° C. to about 400° C., and the time is preferably about 30 min to about 200 min on using an oven.

The thickness of the hardened film obtained may be appropriately adjusted according to desired use, but is preferably about 1 μm to about 200 μm, and further preferably about 1 μm to about 150 μm. The composition of the invention has a low viscosity and excellent storage stability even if the solute concentration is increased, and therefore a thicker hardened film, in comparison with a film formed from a conventional composition, can be easily formed with good productivity.

2-4. Physical Properties of a Hardened Film, or the Like

The hardened film of the invention is obtained by hardening the composition of the invention, and therefore is excellent in being well balanced between film flatness, heat resistance, mechanical characteristics and so forth. The hardened film of the invention preferably contains polyimide (a polymer having a plurality of imide groups). On the occasion, the hardened film has the above characteristics, and also characteristics equivalent to or superior to those of a conventional polyimide film, such as electrical characteristics including the withstand voltage, the dielectric constant and the dielectric loss, mechanical characteristics including the bending test, the elastic modulus and the tensile elongation, chemical stability including acid resistance, alkali resistance and plating resistance, and thermal characteristics including the thermal decomposition temperature, the glass transition temperature and the coefficient of thermal expansion.

Consequently, the hardened film of the invention can be suitably used as an insulating film or a protective film for an electronic component, or the like.

A high 5% weight reduction temperature of the hardened film of the invention is preferred, and when the hardened film is used in an electronics and communication field, especially a semiconductor device, the 5% weight reduction temperature is preferably about 450° C. or higher, and further preferably about 460° C. or higher, in view of the difficulty in generating an outgas from the hardened film upon the use in the field.

A high glass transition temperature of the hardened film of the invention is preferred. The glass transition temperature is preferably about 250° C. or higher, and further preferably in the range of about 260 to about 600° C., in view of obtaining a stable hardened film in various uses.

When the hardened film of the invention is used as an insulating film, the hardened film preferably has about the same coefficient of thermal expansion comparable with the coefficient of the support in view of the difficulty in causing a crack on the hardened film, and the difficulty in causing peeling from a support by thermal stress upon using the hardened film on the support.

Therefore, the coefficient of thermal expansion may be appropriately adjusted according to the support to be used, but when the hardened film is used in an electronics and communication field, the coefficient of thermal expansion is ordinarily about 80 ppm/° C. or less, and further preferably about 70 ppm/° C. or less.

The coefficient of thermal expansion of the hardened film of the invention can be adjusted by appropriately selecting the components (A) and (B) to be used.

### 3. Electronic Component

An electronic component of the invention has the hardened film of the invention. Specific examples thereof include a substrate for an electronic material, more specifically, a film substrate and a semiconductor wafer substrate.

Specific examples of the film substrate include a substrate obtained by coating the composition of the invention on a film-shaped substrate such as a polyimide film on which wiring has been formed in advance by an inkjet printing method or the like to form a coating film, and then hardening the coating film by drying and heating.

The following examples are for illustrative purposes only and are not intended, nor should they be interpreted to, limit the scope of the invention.

### EXAMPLES

Hereinafter, the invention will be explained by way of Examples and Comparative Examples.

The names of the reaction raw materials and the solvents being used in Examples and Comparative Examples are expressed using abbreviations. The abbreviations are used in the following descriptions.

Carboxylic Anhydride (a1)

ODPA: 3,3′,4,4′-diphenyl ether tetracarboxylic dianhydride

PMDA: pyromellitic dianhydride

s-BPDA: 3,3′,4,4′-biphenyl tetracarboxylic dianhydride

4-EPA: 4-ethynyl phthalic anhydride

PTCDA: perylene tetracarboxylic dianhydride

Compound (a2)

ECa: ethylcarbitol

OH group-containing compound

MeOH: methanol

EHeOH: 2-ethyl-1-hexanol

CS-12 (trade name, JNC Corporation): a mixture of 3-hydroxy-2,2,4-trimethylpentyl isobutyrate and 2,2,4-trimethyl-1,3-pentanediol-3-monoisobutyrate

Diamine (B)

BAPP: 2,2-bis[4-(4-aminophenoxy)phenyl]propane

DDE: 4,4′-diaminodiphenyl ether

HFBAPP:

2,2-bis[4-(4-aminophenoxy)phenyl]hexafluoropropane

TPE-R: 1,3-bis(4-aminophenoxy)benzene

DDS: 3,3′-diaminodiphenylsulfone

BAPS-M: bis[4-(3-aminophenoxy)phenyl]sulfone

DMB: 3,3′-dimethoxybenzidine

Solvent (C)

EDM: diethylene glycol ethyl methyl ether

GBL: γ-butyrolactone

### Example 1

Into a 50 mL reaction vessel equipped with a thermometer, a stirrer, a raw material charging inlet and a nitrogen gas inlet, ODPA (2.1521 g) as (a1) and ECa (7.5 g) as (a2) were charged, and the resultant mixture in the reaction vessel was stirred at 130° C. for 4 hours in an oil bath, and thus a uniform liquid was obtained. Then, the resultant liquid was further stirred at 130° C. for 1 hour, and thus carboxylic acid ester (A) was obtained. Next, the reaction vessel was removed from the oil bath and cooled to room temperature. Then, BAPP (2.8479 g) as (B) and EDM (7.5 g) as (C) were added thereto, and the resultant mixture was stirred until a uniform solution was formed, and thus a thermosetting composition was obtained. The evaluations (1) to (6) described later were performed to the composition.

### Examples 2 to 12

A thermosetting composition was prepared under conditions identical with the conditions in Example 1 except that another raw material presented in Table 1 was used, and the evaluations (1) to (6) described below were performed.

### Comparative Example 1

Into a 50 mL flask equipped with a thermometer, a stirrer, a raw material charging inlet and a nitrogen gas inlet, ODPA (2.1521 g) as (a1), BAPP (2.8479 g) as (B) and EDM (15 g) as (C) were charged, and the resultant mixture was stirred at room temperature for 1 hour. Then, a polymer component was confirmed to precipitate in the solution inside of the flask, which was insoluble. Therefore a future evaluation was not performed.

### Comparative Example 2

Into a 50 mL flask equipped with a thermometer, a stirrer, a raw material charging inlet and a nitrogen gas inlet, GBL (22.5 g) as (C) and BAPP (1.42395 g) as (B) were charged, and the resultant mixture was stirred and dissolved at room temperature for 1 hour, and then cooled to 4° C. with ice water. When ODPA (1.0761 g) as (a1) was added, heat generation of about 10° C. was observed. Upon completion of heat generation, the flask was removed from ice water, and the resultant mixture was stirred for 3 hours at room temperature, and thus a thermosetting composition was obtained. The evaluations (1) to (6) described below were performed to the composition. However, after two days from preparation, white turbidity of the composition started, and the storage stability was poor.

### Comparative Example 3

A raw material presented in Table 2 was used in a the same synthesis process of the carboxylic acid ester (A) in Example 1, the temperature of the oil bath was controlled at 70° C., and the resultant mixture was stirred for 24 hours in a manner similar to the operations in Example 1. However, ODPA was not dissolved in MeOH, so a future evaluation was not performed.

### Comparative Example 4

A composition was prepared under conditions similar to the conditions in Example 1 except that another raw material presented in Table 2 was used. However, a precipitate was formed in the flask on the next day, so a future evaluation was not performed.

### Comparative Example 5

A raw material presented in Table 2 was used in the same synthesis process of the carboxylic acid ester (A) in Example 1, and the resultant mixture was stirred for 24 hours in a manner similar to the operations in Example 1. However, ODPA was not dissolved in CS-12, so a future evaluation was not performed.

### Comparative Example 6

A raw material presented in Table 2 was used in the same synthesis process of the carboxylic acid ester (A) in Example 1, and the resultant mixture was stirred for 24 hours in a manner similar to the operations in Example 1. However, PTCDA was not dissolved in EHeOH, so a future evaluation was not performed.

Evaluation Method

The evaluation methods applied in Examples and Comparative Examples are described below.

(1) Viscosity (mPa·s)

The viscosity of a thermosetting composition was measured at 25° C. using a cone-plate (E-type) viscometer (trade name: TV-22, made by Toki Sangyo Co., Ltd.).

(2) Storage Stability at Room Temperature

The storage stability of a thermosetting composition at room temperature was evaluated. The state of the thermosetting composition after 7 days under room temperature was observed. A stable thermosetting composition in which formation of an insoluble matter was not confirmed even on storage at room temperature was evaluated to be good, and a turbid thermosetting composition or a thermosetting composition in which generation of an insoluble matter such as gelated matter was confirmed upon storage at room temperature was evaluated to be bad.

(3) Film Flatness

A thermosetting composition was coated on a base material (aluminum foil) using an applicator, and the resultant coated material was dried at 50° C. for 30 min and then at 80° C. for 30 min using a hot plate. Further, the base material with the coating film obtained was put into an oven, and when the thermosetting composition obtained in Example 1 was used, the film was heated at 250° C. for 120 min, or when the thermosetting compositions obtained in Examples 2 to 12 were used, the films were heated at 200° C. for 30 min and then heated at 400° C. for 30 min, or when the thermosetting composition obtained in Comparative Example 2 was used, the film was heated at 200° C. for 30 min and then heated at 300° C. for 30 min. Thus, a base material with a hardened film (film thickness: 50 μm) was formed. With regard to the film flatness, the hardened film surface of the base material with the hardened film obtained was visually observed, and a uniform film without swelling or unevenness was evaluated to be good.

(4) 5% Weight Reduction Temperature

A base material with a hardened film was prepared in a manner similar to the operations upon evaluating the film flatness, the hardened film was peeled off from the base material with the hardened film obtained, and cut into 3 mm long and 3 mm wide piece. A plurality pieces of cut hardened films were stacked to be about 10 mg in the total weight, put into a sample container (aluminum pan), and a 5% weight reduction temperature of the hardened film was measured using the sample container obtained and Differential Scanning calorimeter (SSC5200, made by Seiko Instruments Inc.).

Measuring conditions are as described below.

Temperature rise starting temperature: 30° C.

Temperature rise finish temperature: 600° C.

Rate of temperature rise: 10° C./min.

Atmosphere: in air.

(5) Glass Transition Temperature

A base material with a hardened film was prepared in a manner similar to the operations upon evaluating film flatness, the hardened film was peeled off from the base material with the hardened film obtained, and cut into 23 mm long and 5 mm wide piece, and then a glass transition temperature of the hardened film was measured using Dynamic Mechanical Spectrometer (DMS 6100, made by Seiko Instruments Inc.).

Measuring conditions are as described below.

Temperature rise starting temperature: 30° C.

Temperature rise finish temperature: 600° C.

Rate of temperature rise: 10° C./min.

Atmosphere: in air.

(6) Coefficient of Thermal Expansion

A base material with a hardened film was prepared in a manner similar to the operations upon evaluating film flatness, the hardened film was peeled off from the base material with the hardened film obtained, and cut into 10 mm long and 3 mm wide piece, and then a coefficient of thermal expansion of the hardened film was measured using Thermomechanical Analyzer (TMA/SS6100, made by Seiko Instruments Inc.).

Measuring conditions are as described below.

Temperature rise starting temperature: 30° C.

Temperature rise finish temperature: 300° C.

Rate of temperature rise: 10° C./min.

Atmosphere: in air.

Calculation of a coefficient of thermal expansion: 50 to 125° C. (first scan).

Results of evaluation in Examples and Comparative Examples as described above are presented in Table 1 or Table 2.

TABLE 1

| | | | | | | | | | | 5% weight | Glass | Co- |
|---|---|---|---|---|---|---|---|---|---|---|---|---|
| | | | | | | Solute | | | | reduction | transition | efficient |
| | | | | | | concen- | | | | tempera- | tempera- | of thermal |
| | A | | | | | tration | Viscosity | Storage | Film | ture | ture | expansion |
| Example | a1 | | a2 | B | C | (wt %) | (mPa · s) | stability | flatness | (° C.) | (° C.) | (ppm/° C.) |
| 1 | ODPA | | Eca | BAPP | EDM | 25 | 13.2 | Good | Good | 519 | 261 | 57 |
| | 2.1521 g | | 7.5 g | 2.8479 g | 7.5 g | | | | | | | |
| 2 | ODPA | | Eca | BAPP | | 40 | 303.0 | Good | Good | 481 | 340 | 41 |
| | 4.3042 g | | 15 g | 5.6958 g | | | | | | | | |
| 3 | ODPA | | Eca | BAPP | EDM | 25 | 13.2 | Good | Good | 481 | 340 | 41 |
| | 2.1521 g | | 7.5 g | 2.8479 g | 7.5 g | | | | | | | |
| 4 | ODPA | | Eca | DDE | EDM | 25 | 19.8 | Good | Good | 545 | 304 | 33 |
| | 3.0387 g | | 7.5 g | 1.9613 g | 7.5 g | | | | | | | |
| 5 | ODPA | | Eca | HFBAPP | EDM | 25 | 11.4 | Good | Good | 526 | 273 | 47 |
| | 1.8718 g | | 7.5 g | 3.1282 g | 7.5 g | | | | | | | |
| 6 | ODPA | | Eca | TPE-R | EDM | 25 | 14.9 | Good | Good | 545 | 263 | 41 |
| | 2.5742 g | | 7.5 g | 2.4258 g | 7.5 g | | | | | | | |
| 7 | PMDA | | Eca | DDS | EDM | 25 | 17.0 | Good | Good | 530 | 310 | 35 |
| | 2.3382 g | | 7.5 g | 2.6618 g | 7.5 g | | | | | | | |
| 8 | s-BPDA | | Eca | HFBAPP | EDM | 25 | 11.7 | Good | Good | 523 | 298 | 59 |
| | 1.8102 g | | 7.5 g | 3.1898 g | 7.5 g | | | | | | | |
| 9 | s-BPDA | | Eca | BAPS-M | EDM | 25 | 12.4 | Good | Good | 530 | 299 | 38 |
| | 2.0243 g | | 7.5 g | 2.9757 g | 7.5 g | | | | | | | |
| 10 | ODPA | 4-EPA | Eca | HFBAPP | EDM | 25 | 10.5 | Good | Good | 511 | 360 | 55 |
| | 0.9171 g | 1.0177 g | 7.5 g | 3.0652 g | 7.5 g | | | | | | | |
| 11 | s-BPDA | 4-EPA | Eca | HFBAPP | EDM | 25 | 11.1 | Good | Good | 512 | 391 | 47 |
| | 0.8781 g | 1.0275 g | 7.5 g | 3.0945 g | 7.5 g | | | | | | | |

| | | | | | | | | | | | | |
|---|---|---|---|---|---|---|---|---|---|---|---|---|
| 12 | 4-EPA | Eca | HFBAPP | DMB | EDM | 25 | 12.0 | Good | Good | 469 | 505 | 46 |
| | 2.3722 g | 7.5 g | 1.7862 g | 0.8416 g | 7.5 g | | | | | | | |

TABLE 2

| | A | | | | | | | | 5% weight | Glass | Coefficient |
|---|---|---|---|---|---|---|---|---|---|---|---|
| | | OH- | | | Solute | | | | reduction | transition | of thermal |
| Comparative | | containing | | | concentration | Viscosity | Storage | Film | temperature | temperature | expansion |
| Example | a1 | compound | B | C | (wt %) | (mPa · s) | stability | flatness | (° C.) | (° C.) | (ppm/° C.) |
| 1 | ODPA | — | BAPP | EDM | 25 | — | — | — | — | — | — |
| | 2.1521 g | | 2.8479 g | 15 g | | | | | | | |
| 2 | ODPA | — | BAPP | GBL | 10 | 6,000 | Bad | Good | 480 | 285 | 55 |
| | 1.0761 g | | 1.42395 g | 22.5 g | | | | | | | |
| 3 | ODPA | MeOH | — | — | — | — | — | — | — | — | — |
| | 2.1521 g | 7.5 g | | | | | | | | | |
| 4 | ODPA | EHeOH | BAPP | EDM | 25 | 13.6 | Bad | — | — | — | — |
| | 2.1521 g | 7.5 g | 2.8479 g | 7.5 g | | | | | | | |
| 5 | ODPA | CS-12 | — | — | — | — | — | — | — | — | — |
| | 2.1521 g | 7.5 g | | | | | | | | | |
| 6 | PTCDA | EHeOH | — | — | — | — | — | — | — | — | — |
| | 2.7217 g | 7.5 g | | | | | | | | | |

As is clear from the results in Examples and Comparative Examples as described above, the thermosetting compositions obtained in Examples 1 to 12 formed no insoluble matter in storage at room temperature at least for 7 days, and could be stably stored. In Examples 1 to 12, the carboxylic acid ester (A) and the thermosetting composition are easily manufactured. Even when the compositions obtained in Examples 1 to 12 have a solute concentration of 40 wt %, a conventional and publicly known coating method can be applied, and the storage stability is excellent.

The surfaces of the hardened films formed from the compositions obtained in Examples 1 to 12 were uniform, and neither swelling nor unevenness was observed.

Moreover, the hardened films formed from the compositions obtained in Examples 1 to 12 have a 5% weight reduction temperature and a glass transition temperatures exceeding 450° C. and 250° C., respectively, and a coefficient of thermal expansion of 80 ppm/° C. or less, and the hardened films are found to have characteristics required by an insulating film in the field of electronics and communication.

As is clear from the results in Examples as described above, the thermosetting composition of the invention has a low viscosity and excellent storage stability even when the solute concentration is high, and a superior hardened film well balanced between coating film flatness, heat resistance, mechanical characteristics and so forth can be obtained therefrom.

Accordingly, the thermosetting composition of the invention can be suitably used, e.g., for an insulating film for a printed circuit board and an insulating film for a semiconductor device, and also as a material for forming electronic components.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

What is claimed is:

1. A thermosetting composition comprising:
(A) a carboxylic acid ester having at least one group represented by formula (1); and
(B) a diamine, 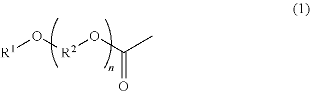
wherein in formula (1), R¹ is alkyl having 1 to 10 carbons, R² is independently alkylene having 2 or 3 carbons, and n is an integer of 1 to 3.

2. The thermosetting composition of claim 1, wherein the carboxylic acid ester (A) is obtained by allowing a carboxylic anhydride (a1) to react with a compound (a2) represented by formula (2):

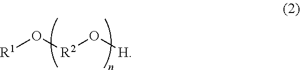

3. The thermosetting composition of claim 2, wherein the carboxylic anhydride (a1) is at least one compound selected from the group consisting of a tetracarboxylic anhydride and a dicarboxylic anhydride having a thermo-reactive unsaturated bond.

4. The thermosetting composition of claim 2, wherein the carboxylic anhydride (a1) is at least one compound selected from the group consisting of 3,3′,4,4′-biphenyl tetracarboxylic dianhydride, pyromellitic dianhydride, 3,3′,4,4′-benzophenone tetracarboxylic dianhydride, 2,2′,3,3′-benzophenone tetracarboxylic dianhydride, 2,3,3′,4′-benzophenone tetracarboxylic dianhydride, 3,3′,4,4′-diphenylsulfone tetracarboxylic dianhydride, 2,2′,3,3′-diphenylsulfone tetracarboxylic dianhydride, 2,3,3′,4′-diphenylsulfone tetracarboxylic dianhydride, 3,3′,4,4′-diphenylether tetracarboxylic dianhydride, 2,2′,3,3′-diphenylether tetracarboxylic dianhydride, 2,3,3′,4′-diphenylether tetracarboxylic dianhydride, 2,2-[bis(3,4-dicarboxyphenyl)]hexafluoropropane dianhydride, ethyleneglycol bis(anhydrotrimellitate), 4,4′-[(isopropylidene)bis(p-phenyleneoxy)]diphthalic dianhydride, cyclobutane tetracarboxylic dianhydride, methylcyclobutane tetracarboxylic dianhydride, cyclopentane tetracarboxylic dianhydride, 1,2,4,5-cyclohexane tetracarboxylic dianhydride, ethane tetracarboxylic dianhydride, butane tetracarboxylic dianhydride, 3,3′,4,4′-bicyclohexyl tetracarboxylic dianhydride, 4-ethynyl phthalic anhydride and 4-phenylethynyl phthalic anhydride.

5. The thermosetting composition of claim 1, wherein the diamine (B) is at least one compound selected from the group consisting of 3,3′-diaminodiphenylsulfone, 4,4′-diaminodiphenyl ether, bis[4-(3-aminophenoxy)phenyl]sulfone, 3,3′-diaminodiphenylmethane, 4,4′-diaminodiphenylmethane, 2,2′-diaminodiphenylpropane, 3,3′-dimethyl-4,4′-diaminodiphenylmethane, 2,2-bis[4-(4-aminophenoxy)phenyl]propane, 2,2-bis[4-(4-aminophenoxy)phenyl]hexafluoropropane, m-phenylenediamine, p-phenylenediamine, m-xylylenediamine, p-xylylenediamine, benzidine, 1,1-bis[4-(4-aminophenoxy)phenyl]cyclohexane, 1,1-bis[4-(4-aminophenoxy)phenyl]-4-methylcyclohexane, 1,1-bis[4-(4-aminobenzyl)phenyl]cyclohexane, 1,1-bis[4-(4-aminobenzyl)phenyl]-4-methylcyclohexane, 1,1-bis[4-(4-aminobenzyl)phenyl]methane, 1,3-bis(4-aminophenoxy)benzene, diethylene glycol bis(3-aminopropyl)ether, 3,3′-dimethoxybenzidine, isophoronediamine, 3,3′-dihydroxybenzidine, a dimer acid diamine and a compound represented by formula (3): 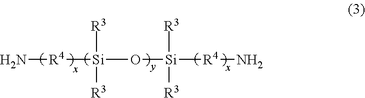
wherein in formula (3), R³ is independently alkyl having 1 to 3 carbons or phenyl, R⁴ is independently methylene or phenylene, at least one hydrogen of the phenylene may be replaced by alkyl having 1 to 6 carbons, x is independently an integer of 1 to 6, and y is an integer of 1 to 70.

6. The thermosetting composition of claim 1, further comprising a solvent (C).

7. A hardened film, obtained by hardening the thermosetting composition of claim 1.

8. An electronic component having the hardened film of claim 7.
